(19) United States
(12) Patent Application Publication
(10) Pub. No.: US 2025/0226603 A1
(43) Pub. Date: Jul. 10, 2025

(54) CARD EDGE CONNECTOR WITH ABSORPTIVE MATERIAL

(71) Applicant: FCI USA LLC, Etters, PA (US)

(72) Inventors: Charles Copper, Hummelstown, PA (US); Jeffrey Toran, New Cumberland, PA (US); Jose Ricardo Paniagua, Newmarket, NH (US)

(73) Assignee: FCI USA LLC, Etters, PA (US)

(21) Appl. No.: 18/729,130

(22) PCT Filed: Jan. 18, 2023
(86) PCT No.: PCT/US2023/011018

§ 371 Date: Jul. 15, 2024

Related U.S. Application Data
(60) Provisional application No. 63/300,590, filed on Jan. 18, 2022.

(51) Int. Cl. H01R 12/72; H01R 13/03; H01R 13/05; H01R 13/6461

(52) U.S. Cl. CPC H01R 12/721; H01R 13/03; H01R 13/05; H01R 13/6461

(57) ABSTRACT

A component for improving the performance of computers using high speed memories while retaining the flexibility to install only a subset of the memories the computer can support. The component may have a blade portion configured for insertion into the mating interface of connectors forming memory sockets in the computer. The blade portion may include absorptive material selectively placed adjacent conductive elements within the connector so as to damp or prevent undesirable electromagnetic characteristics, such as stub resonances, within memory sockets that are not populated with memories. The component may have absorptive material coupled to signal and ground conductive elements of unpopulated card edge connectors and may have insulative regions that provide isolation between the absorptive material and power conductive elements. The component may be shaped for easy insertion and retention and later removal from the connector to allow a memory card to be later added to the computer.

### BACKGROUND

The present application relates generally to card edge connectors, and in particular, to a card edge connector used in computers to receive a memory card.

Card edge connectors are used widely in electrical systems. It is generally easier and more cost effective to manufacture components of an electrical system on several printed circuit boards (PCBs), and to connect the PCBs to other components of the electrical system using card edge connectors than to manufacture the electrical system as a single component. Sometimes, one PCB may be used as a main board or motherboard, while other PCBs in the system may be referred to as daughter boards or daughter cards that are connected to the motherboard by card edge connectors to interconnect these PCBs. In a computer, card edge connectors may be used on a motherboard to receive a memory card, a graphics card, or other PCBs that provide other functionalities.

One type of a card edge connector is a memory socket for receiving a memory card. The memory socket may be used, for example to interconnect a memory daughter card with a motherboard. DDR5 (Double Data Rate Gen 5) is a memory specification widely used in computers today. A daughter card using DDR5 may be interconnected with the motherboard of a computer through a card edge connector. The card edge connector is fixed on the motherboard, and conductive elements on the card edge connector are interconnected with circuits on the motherboard. The daughter card is inserted into the card slot of the card edge connector, so that the pads on the daughter card are electrically connected with corresponding conductive elements on the card edge connector, so as to provide electrical interconnection with circuitry on the motherboard through the card edge connector.

A known card edge connector includes a housing having a slot defined by two opposing side walls for receiving a daughter card. Each of the opposing side wall may include a row of openings exposing a plurality of conductive elements. A mating contact portion of a conductive element may extend into the slot through a corresponding opening in the side wall, such that when a daughter card is inserted into the slot, the conductive element may be electrically connected with a corresponding conductive pad on the daughter card via the contact portion. The card edge connector may also include an ejector for ejecting the daughter card and a lock for locking the daughter card in the slot.

Computers may be manufactured with multiple card edge connectors to receive multiple memory cards. Some computers may be manufactured with memory cards in all of those connectors. For cost reasons, other computers of the same design may be manufactured with memory cards in only some of the connectors. The user of those computers then has the option to later add memory cards where more performance from the computer is desired.

### SUMMARY

Some embodiments relate to a component for insertion into an unpopulated electrical connector that comprises a mating interface. The component comprises a blade portion configured for insertion into the mating interface. The blade portion comprises a lossy body.

Such a component may include one or more of the following features: the lossy body may comprise a binder and ferrite fillers disposed within the binder. The lossy body may comprise a binder and conductive fillers disposed within the binder. The lossy body may have a bulk conductivity, measured at a frequency of 1 GHz of between 50 and 1,000 siemens/meter. The binder may comprise a thermoplastic. In some embodiments, the binder may be nylon. The component may further comprise a cap mechanically coupled to the blade portion. In some embodiments, the component is a dust cap. The component may be a pick and place cap. The blade portion may comprise opposing edges and at least one notch in each of the edges configured to receive an engagement feature of the electrical connector.

In some embodiments, the blade portion may have physical dimensions in accordance with a DDR5 specification. The lossy body may comprise a plurality of insulative recesses configured to align with power conductive elements of the electrical connector.

Some embodiments relate to an electrical connector comprising an insulative housing; a plurality of conductive elements disposed in the insulative housing; and an insert having at least a portion disposed adjacent at least one conductive element of the plurality of conductive elements. The portion comprises an absorptive material.

In some embodiments, the insert is removable. In some embodiments, the absorptive material comprises an electrically lossy material. In some embodiments, the absorptive material comprises a magnetically lossy material.

In some embodiments, the portion is adjacent at least two conductive elements of the plurality of conductive elements, and the absorptive material is configured to electrically bridge the at least two conductive elements. In some embodiments, the at least two conductive elements comprises a ground conductor. In some embodiments, the at least two conductive elements comprises a signal conductor. In some embodiments, the absorptive material is in direct physical contact with the ground conductor. In some embodiments, the absorptive material is in direct physical contact with the signal conductor. In some embodiments, the absorptive material is capacitively coupled to the signal conductor. In some embodiments, the portion of the insert comprises an insulative layer between the absorptive material and the signal conductor. In some embodiments, the absorptive material is not in direct physical contact with a power conductor of the plurality of conductive elements. In some embodiments, the electrical connector is a card edge connector configured to mate with a daughtercard, the insulative housing comprises a slot configured to receive the daughtercard, and the portion of the insert is disposed in the slot. Some embodiments relate to a computer system that comprises such a card edge connector. In such embodiments, the card edge connector is a first card edge connector, and the computer system further comprises a second card edge connector mated with a memory card.

In some embodiments, the insert further comprises a cap covering at least a surface of the insulative housing outside the slot. In some embodiments, the daughtercard is a memory card.

Some embodiments relate to a removable insert configured to be inserted into a slot of a card edge connector. The card edge connector comprises a plurality of conductive elements. The removable insert comprises at least a portion configured to be disposed in the slot and adjacent at least one conductive element of the plurality of conductive elements, the portion comprising an absorptive material.

In some embodiments, the removable insert comprises a dust cap. In some embodiments, the absorptive material comprises an electrically lossy material. In some embodiments, the absorptive material comprises a magnetically lossy material.

In some embodiments, the portion is configured to be adjacent at least two conductive elements of the plurality of conductive elements, and the absorptive material is configured to electrically bridge the at least two conductive elements. In some embodiments, the absorptive material is configured to be in direct physical contact with a ground conductor in the card edge connector. In some embodiments, the absorptive material is configured to be in direct physical contact with a signal conductor in the card edge connector. In some embodiments, the absorptive material is configured to be capacitively coupled with a signal conductor in the card edge connector. In some embodiments, the portion of the insert comprises an insulative layer disposed on the absorptive material and configured to separate the absorptive material from the signal conductor. In some embodiments, the card edge connector is configured to be mated to a memory card after removal of the insert.

Some embodiments relate to a computer system comprising a memory bus; a plurality of card edge connectors, each of the plurality of card edge connectors coupled to the memory bus and comprising a respective mating interface; a memory card; and an absorptive blade. The plurality of card edge connectors comprises a first card edge connector and a second card edge connector; the memory card is inserted in the mating interface of the first card edge connector; and the absorptive blade is inserted in the mating interface of the second card edge connector.

Such a computer system may include one or more of the following features: the memory bus comprises a plurality of signal conductors; the computer system comprises at least one power conductor and at least one ground conductor; each of the plurality of card edge connectors comprises: a plurality of signal conductive elements, each of the plurality of signal conductive elements soldered to a respective signal conductor of the plurality of signal conductors; a plurality of power conductive elements, each of the plurality of power conductive elements soldered to a respective power conductor of the at least one power conductor; a plurality of ground conductive elements, each of the plurality of ground conductive elements soldered to a respective ground conductor of the at least one ground conductor; and the plurality of ground conductive elements of the second card edge connector are electrically coupled to the absorptive blade.

In some embodiments, the absorptive blade comprises a lossy body and the plurality of ground conductive elements of the second card edge connector are electrically coupled to the absorptive blade via an ohmic connection. In some embodiments, the absorptive blade comprises a lossy body and the plurality of signal conductive elements of the second card edge connector are electrically coupled to the absorptive blade.

In some embodiments, the plurality of signal conductive elements of the second card edge connector are electrically coupled to the lossy body via a capacitive coupling with a capacitance of between 0.01 picoFarad to 1.00 picoFarad of capacitance as measured at a frequency of 1 GHz. In some embodiments, the absorptive blade comprises a lossy body and the plurality of power conductive elements of the second card edge connector are electrically isolated from the lossy body by a DC resistance greater than 1 MOhm.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a perspective view of a card edge connector with an insert having absorptive material, in accordance with some embodiments;

FIG. 2 is a perspective view diagram of the card edge connector in FIG. 1 with the insert fully inserted in the slot, in accordance with some embodiments;

FIG. 3 is a cross sectional view a card edge connector, in accordance with some embodiments;

FIG. 4A is a top plan view of an exemplary card edge connector with an absorptive insert, partially cut away and installed, in accordance with some embodiments;

FIGS. 4B-4E are cross sectional views of segments of alternative embodiments of an absorptive insert that may be inserted into the card edge connector of FIG. 4A, in accordance with some embodiments;

FIG. 5A is perspective view of a dust cap for a connector such as the card edge connector in FIG. 1 with an absorptive blade portion, in accordance with some embodiments;

FIG. 5B is perspective view of a portion of a connector such as the card edge connector in FIG. 1 with the housing shown in phantom and pick and place cap with an absorptive blade portion inserted into the mating interface of the connector, in accordance with some embodiments;

FIG. 6A is plot, derived through electromagnetic modeling, of S-parameters of a connector with a DDR memory card inserted;

FIG. 6B is a plot, derived through electromagnetic modeling of S-parameters of the same connector used to generate FIG. 6A, but with the connector unpopulated; and

FIG. 6C is a plot, derived through electromagnetic modeling, of S-parameters of the same connector used to generate FIG. 6B with an insert having absorptive material to dampen stub resonance.

### DETAILED DESCRIPTION

The inventors have recognized and appreciated designs and methods for improving the performance of computers using high speed memories while retaining the flexibility to install only a subset of the memories the computer can support. Such designs and methods may be implemented inexpensively with little or no disruption in existing processes for manufacturing, distributing and using computers.

Aspects of the present application relate to a component comprising absorptive material that may be removably inserted in a card edge connector. The component may selectively place absorptive material adjacent to or separated from conductive elements within the connector. The absorptive material, for example, may be insulated from power terminals of the connector, but may be coupled to ground terminals and/or signal terminals. The absorptive material may be positioned to dampen or eliminate undesirable electromagnetic characteristics associated with unterminated stubs that may otherwise be present in a card edge connector in which no card is installed, even though the connector is attached to a bus on computer motherboard and configured for connecting high speed memories, such as DDR5 or faster memories, to the computer motherboard. The beneficial effects of damping or eliminating undesirable electromagnetic characteristics may be achieved without undesirably impacting performance of the computer system in which the connector is installed.

With such a component, a computer system manufacturer may pre-install a number of card edge connectors on a motherboard and ship the computer system to a customer without memory cards installed in all of the connectors. For example, conductive elements in a card edge connector may be soldered onto corresponding pads on a motherboard. A computer system may have some, but not all card edge connectors mated to a daughtercard such that the computer system is only partially populated with daughtercards. For example, the card edge connectors may provide a number of memory sockets and some, but not all, of the memory sockets may have memory cards installed. The unpopulated card edge connectors provide flexibility for a customer to determine whether to add more memory cards to the computer system based on the customer's unique computing power and cost requirements, among other considerations. As a result, sometimes a computer system may be operated with one or more unpopulated card edge connectors.

A conductive element in an unpopulated card edge connector that is interconnected to a signal path on the motherboard can act as an unterminated stub. An unterminated stub can impact the signal integrity (SI) and electromagnetic interference (EMI) performance of the computer system. An unterminated stub can, under some conditions, cause signal reflections or other distortions of a signal passing through the mating contacts, degrading signal integrity. These reflections from an unterminated stub, for example, may lead to stub resonances, which may lower the quality of the signals carried in the motherboard. An unterminated stub may cause significant interference when the length is an appreciable fraction of the wavelength of signals propagating through the mating contacts. As the frequency of the signal increases, the wavelength decreases such that for a high frequency signal, what might appear as a relatively short stub may cause significant signal disruptions. Moreover, an unterminated stub may act as an antenna and the stub resonance may generate electromagnetic radiations that could lead to crosstalk with adjacent conductive elements or high emission levels that could exceed a regulatory EMI requirement for a computer system in certain conditions. As these problems are frequency dependent, an unpopulated card edge connector connected to signal lines in a computer designed to connect to high speed memories may be particularly susceptible to these negative effects. For example, a computer with an unpopulated socket designed to receive a DDR5 memory card has a mating contact portion that extends a few mm (e.g. 6 mm) in length and may cause stub resonance within the frequency range of high speed signals on the memory bus to which that socket is connected. Such undesirable electromagnetic characteristics in the operating frequency range of the memory bus may create a particular high risk of interfering with operation of the memory bus.

According to some aspects of the present disclosure, an unpopulated card edge connector may be provided with an insert having absorptive material disposed in the slot adjacent conductive elements in the card edge connector. The absorptive material may dampen or eliminated stub resonances in conductive elements acting as unterminated stubs, such that SI and EMI performance of the computer system having the unmated card edge connector may be improved.

In some embodiments, the absorptive material may comprise a lossy material, such as an electrically lossy material, magnetically lossy material, or combinations thereof.

The absorptive material in the insert may be selectively placed adjacent some or all of the conductive elements to provide bridging between conductive elements. Bridging can be provided by direct physical contact between a conductive element and the absorptive material, by capacitive coupling, or a combination thereof as aspects of the present disclosure are not so limited. For example, an absorptive material may bridge two conductive elements by being in direct physical contact with both conductive elements; by being capacitively coupled with both conductive elements, or by being in direct physical contact with one conductive element, while capacitively coupled to the other conductive element. Capacitive coupling may be provided by separation between a conductive and absorptive material via a relatively small gap. That gap may be filled with a dielectric, which may be, for example, air or a layer of dielectric material.

In some embodiments, the absorptive material may provide bridging between all of the conductive elements or some of the conductive elements. More than one absorptive material may be provided within an insert. In some embodiments, groups of conductive elements within a card edge connector may be bridged together within each group by an absorptive material, but otherwise electrically isolated from other groups.

The conductive elements that are bridged by the absorptive material or isolated from the absorptive material may depend on the function of the conductive elements in the connector when the connector is populated with a memory. For example, a card edge connector may have some conductive elements that are configured to carry power, some configured to be connected to ground and others that are configured to carry high speed signals. These configurations may result from how the connector is connected to the motherboard, as a motherboard with a memory bus will have conductive structures for carrying power, signal and ground. In some embodiments, conductive elements in the card edge connector may be configured to be a power conductor, a ground conductor, or a signal conductor based on the specification of the daughter card to be mated to that connector.

For example, absorptive material may be selectively positioned to provide bridging between a ground conductor and one or more signal conductors. In some embodiments, the absorptive material may be shaped or patterned to have protrusions towards select conductive elements. The projections may enhance coupling to those conductive elements. Alternatively or additionally, the absorptive material may contain recesses positioned to align with certain consecutive elements. Recesses may provide separation between the absorptive material and those conductive elements.

In some embodiments, the absorptive material may be selectively positioned to bridge some or all of the signal and ground conductors in a card edge connector, while avoiding direct physical contact to a power conductor to reduce the risk of creating an electrical short between a power conductor and a ground or signal conductor.

The insert may be shaped to facilitate placement within the slot of the card edge connector such that the absorptive material is positioned adjacent conductive elements of the card edge connector. The insert may be removable and may be replaced with a daughtercard.

In some embodiments, the insert may comprise a blade configured to be inserted into the slot of the card edge connector. The blade may have dimensions and features that mirror those of the edge of a card designed for insertion into the connector. The blade may comprise, for example, positional elements such as one or more notches configured to engage a locking mechanism on a card edge connector to maintain the blade in place after insertion, and to engage an ejector mechanism on the card edge connector to facilitate removal of the blade from the slot, for example when replacing the insert with a daughtercard.

In some embodiments, the insert may have substantially the same dimensions as a daughter card, such as a DDR5 memory card configured to be mated with the card edge connector. However, in some embodiments, the insert may be simply manufactured and low cost.

Further, in some embodiments, the insert may be incorporated into a component that might otherwise be used in connection with a connector. An insert, for example, may additionally or alternatively be integrated into a protective cap for the card edge connector. The component may substantially seal contact portions of conductive elements in the card edge connector, blocking ingress of dust, moisture and other, solder flux of gas or other contaminants, and may alternatively or additionally seal other parts of the card edge connector from the environment. As another example, the insert may be integrated into a pick and place cap, providing surface area for a pick and place machine to grasp the connector as it is being mounted to the motherboard for surface mount soldering.

The aspects and embodiments described above, as well as additional aspects and embodiments, are described further below. These aspects and/or embodiments may be used individually, all together, or in any combination of two or more, as the disclosure is not limited in this respect.

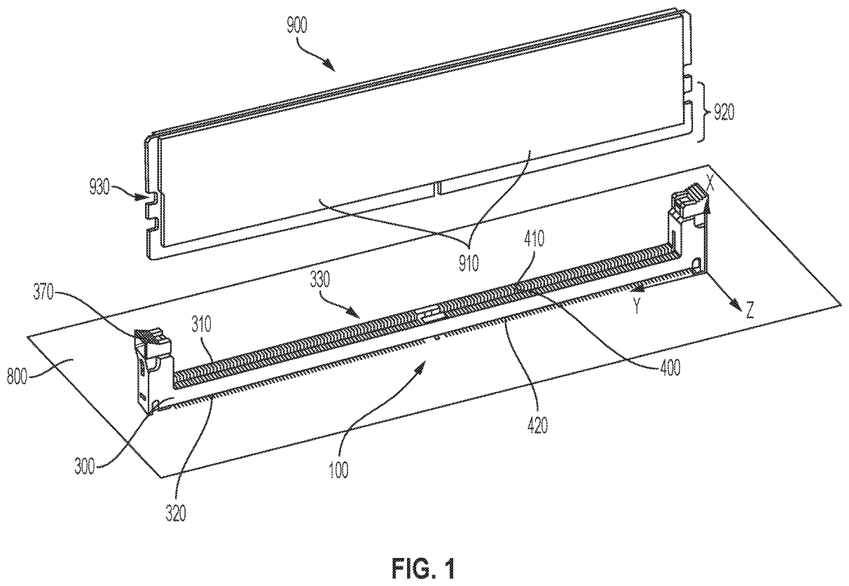

FIG. 1 is a perspective view of a card edge connector and an insert having absorptive material, in accordance with some embodiments. FIG. 1 shows a card edge connector 100 that includes an insulative housing 300. Insulative housing 300 has a first sidewall 310 and second sidewall 320 opposite each other. The first sidewall 310 and second sidewall 320 are elongated in a direction denoted Y in FIG. 1. The first sidewall 310 and second sidewall 320 are separated in a direction denoted the Z direction in FIG. 1. Housing 300 has a slot 330 between first sidewall 310 and second sidewall 320 that is similarly elongated in the Y direction.

A plurality of conductive elements 400 are disposed in the insulative housing 300 and arranged in two opposing rows. In the example of FIG. 1, each row of conductive elements 400 are supported by a respective one of sidewalls 310, 320 with mating contact portions of the conductive elements 400 extending through the sidewall into slot 330. Within each row, the conductive elements 400 are spaced apart along the Y direction.

Each conductive element 400 is attached to PCB 800. The conductive element generally extends vertically from a printed circuit board (PCB) 800 in a direction labeled as the X direction in FIG. 1. Each conductive element 400 has a contact tail 420 for interconnecting with a corresponding conductive pad in the PCB 800 such that connector 100 is physically affixed to the PCB 800 and electrically interconnected with components in the PCB 800. For example, contact tail 420 may be a surface-mount tail that is soldered to a surface pad on PCB 800 via a surface mount solder joint, although other types of interconnections between contact tails 420 and PCB 800 may be used, such as but not limited to compression fitting or an eye-of-the-needle type pressfit.

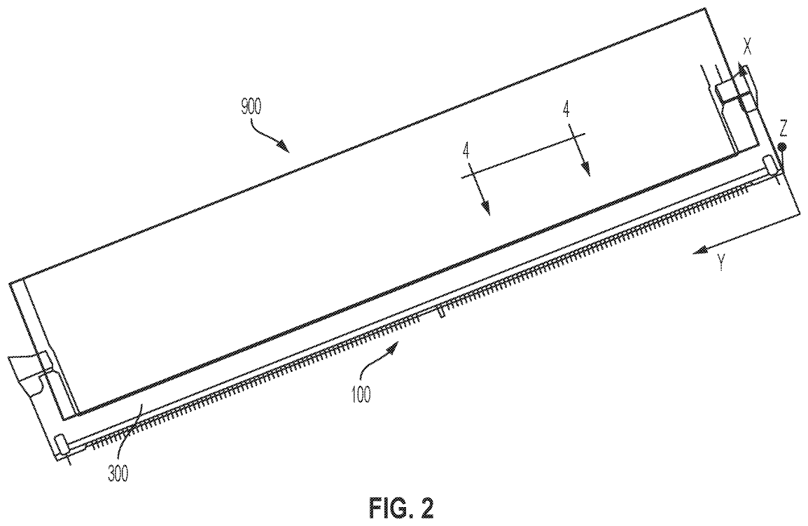

Still referring to FIG. 1, insert 900 is shown removed from the card edge connector 100. Insert 900 has a blade portion 920 that is shaped to be inserted into slot 330 of the connector 100. Blade portion 920 may be wholly or partially formed of an absorptive material. In this example, a region of absorptive material 910 is shown. Here, the region of absorptive material is positioned to be adjacent some or all of the conductive elements 400 when the blade portion 920 is fully inserted into slot 330. FIG. 2 is a perspective view of card edge connector 100 in FIG. 1 with insert 900 fully inserted in the slot.

In some embodiments, card edge connector 100 in FIG. 1 may be a connector for a memory card, such as a DDR5 memory card. Insert 900 may have a thickness and other dimensions and features that match those of a memory card that connector 100 is designed to receive. For example, optionally, insert 900 may have notches 930 that are shaped to engage with locking mechanisms 370 along both side edges of connector 100. Locking mechanisms 370 may move into notches 930 after the insert 900 is fully inserted to the slot 330 to prevent the insert 900 from being unintentionally removed. Optionally, connector 100 may comprise an ejector that may be operated to push against a portion of the insert 900 to facilitate removal of the insert 900 out of the slot 330.

Notches 930 may be shaped and positioned according to a specification of memory card now known or later developed such that the same locking mechanism on the card edge connector for locking a memory card may be used to secure insert 900.

It should be appreciated that FIG. 1 only illustrates one non-limiting example of an insert configured to mate to a card edge connector. A dampening effect of stub resonance may be achieved when the absorptive material 910 within blade portion 920 is positioned adjacent some or all of the conductive elements 400, regardless of the shape, dimension or composition of the insert 900 outside of the region of absorptive material 910.

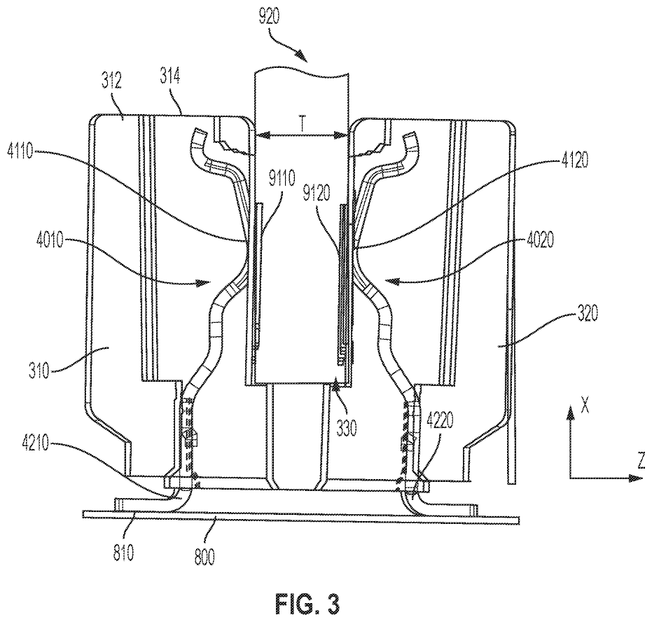

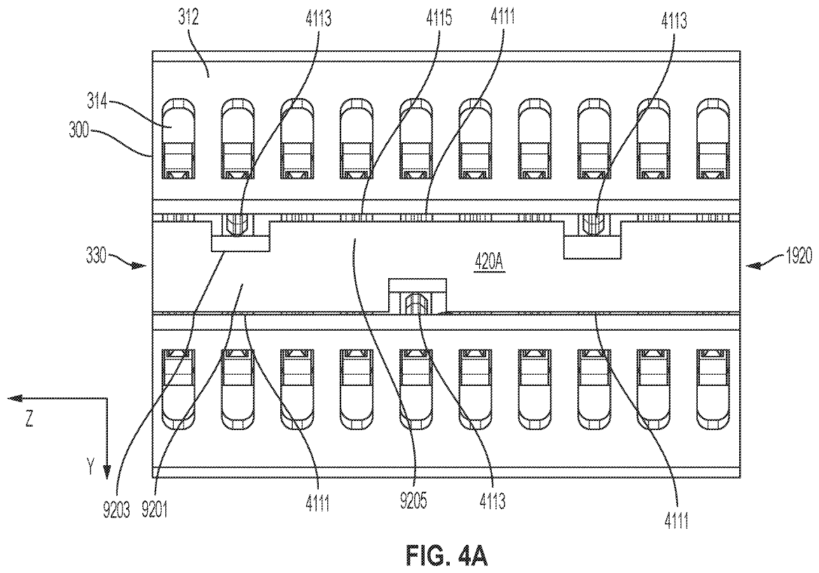

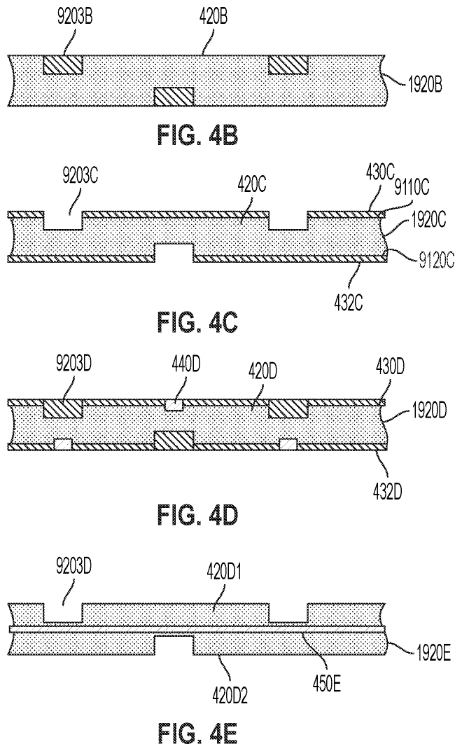

An example construction of an insert with absorptive material is described below with reference to FIG. 3 and FIG. 4.

FIG. 3 is a cross-section view of a card edge connector 100 with an insert having absorptive material along the X-Z plane, in accordance with some embodiments. FIG. 3 shows a blade portion 920 of an insert that is fully inserted into slot 330 of a card edge connector 100.

FIG. 3 shows two conductive elements 4010 and 4020 of connector 100 disposed on opposing sides of slot 330. Depending on the specification of the card edge connector, and position within the connector, each conductive element may be a power conductor, a signal conductor, or a ground conductor.

Conductive element 4010 has a tail portion 4210 connected to corresponding conductive feature such as a pad 810 on a top surface of PCB 800, such as by surface mount soldering. Conductive element 4010 also has a mating contact portion 4110 having a contact surface facing the slot 330, such that when a daughtercard is mated with card edge connector 100, a corresponding pad on a card edge of the daughtercard is placed into electrical and physical contact with the contact surface of mating contact portion 4110. Conductive element 4010 extends vertically along the X direction from the contact tail 4210 to the mating contact portion and may extend beyond the mating contact portion 4110. In some embodiments, the distance of the conductive element from the pad 810 on PCB 800 may be several mm, such as between 1 and 10 mm, between 2 and 8 mm, or between 3 and 7 mm.

When card edge connector 100 is unpopulated and without insert 900, conductive element 4010 forms an unterminated stub on pad 810 of PCB 800. According to an aspect of the present disclosure, the blade portion 920 may dampen or eliminate undesirable stub resonance effects attributable to such an unterminated stub, and as a result, improve SI and EMI performance.

Conductive element 4020 also includes tail portion 4220 and mating contact portion 4120. Each of conductive elements 4010, 4020 may form a compliant spring such that mating contact portions 4110, 4120 may move laterally along the Z direction. Prior to insertion of insert 900, mating contact portions 4110, 4120 may be spaced closer to each other than a width of slot 330 along the Z direction. In some embodiments, mating contact portions 4110, 4120 may extend into slot 330 in a rest position prior to insertion of an insert or a daughtercard in slot 330. A thickness T of the blade portion 920 along the Z direction may be designed to be wider than the rest position distance between mating contact portions 4110, 4120 such that when blade portion 920 is inserted into slot 330, a first surface 9110 of the blade portion contacts the mating contact portion 4110 and pushes mating contact portion 4110 laterally along the Z direction away from the slot 330 and closer to sidewall 310. Thickness T, for example, may be between 1 mm and 5 mm, between 1 mm and 2 mm, or between 1 and 1.5 mm, or may be substantially the thickness of a daughtercard configured to be mated with the card edge connector 100. For example, the thickness T may be 1.2 mm +/−10%.

Upon insertion, a second surface 9120 of the blade portion 920 contacts the mating contact portion 4120 and pushes mating contact portion 4120 laterally along the Z direction away from the slot 330 and closer to sidewall 320. The Z direction contact force between mating contact portion 4110 and first surface 9110 and/or between mating contact portion 4120 and second surface 9120 may help hold the blade portion 920 in place in the slot 330 against accidental removal along the X direction by friction. Such a retention mechanism may be used instead of or in addition to mechanical locking features, such as notches 930 and locking mechanisms 370.

In addition, the Z direction contact force maintains physical direct contact between the mating contact portion 4110 and the first surface 9110 between mating contact portion 4120 and second surface 9120. In embodiments in which the first and second surfaces 9110 and 9120 are themselves made of absorptive material, such a contact force helps maintain direct electrical contact between mating contact portion 4110 and absorptive material at the first surface 9110. If first and second surfaces 9110 and 9120 are formed with one or more dielectric layers separating an absorptive material within blade portion 920 from mating contact portions 4110 and/or 4120, the contact force between blade portion 920 and mating contact portions 4110 and/or 4120 can help maintain a constant separation between mating contact portions 4110 and/or 4120 and the absorptive material. That separation, for example, may equal the thickness of the dielectric layers. A constant separation, for example, may provide a constant capacitive coupling based on the thickness of the intervening dielectric layers, and as a result, electromagnetic characteristic of the connector with a blade portion 920 installed can be precisely maintained.

Some aspects of the present disclosure are directed to placing absorptive material within blade portion 920 adjacent the first surface 9110 and/or the second surface 9120 to dampen stub resonance in some or all of the conductive elements, such as conductive element 4010 and/or 4020. The inventors have recognized and appreciated that selective placement of absorptive material adjacent conductive elements that act as unterminated stubs may improve the overall performance of a computer system containing one or more unpopulated connectors.

An example of absorptive material is lossy material. Examples of lossy material that may be used as absorptive material in embodiments disclosed herein are generally described in U.S. Pat. No. 6,786,771, issued Sep. 7, 2004, titled “INTERCONNECTION SYSTEM WITH IMPROVED HIGH FREQUENCY PERFORMANCE,” U.S. Pat. No. 7,371,117, issued May 13, 2008, titled “HIGH SPEED, HIGH DENSITY ELECTRICAL CONNECTOR,” U.S. Pat. No. 8,371,875, issued Feb. 12, 2013, titled “HIGH SPEED, HIGH DENSITY ELECTRICAL CONNECTOR,” U.S. Pat. No. 8,864,521, issued Oct. 21, 2014, titled “HIGH FREQUENCY ELECTRICAL CONNECTOR,” and U.S. Pat. No. 9,705,255, issued Jul. 11, 2017, titled “HIGH FREQUENCY ELECTRICAL CONNECTOR,” each of which is incorporated by reference in its entirety.

As one example, a thermoplastic material serving as the binder may be filled with conducting particles. The fillers make the thermoplastic material “lossy.” Fillers may be incorporated into a binder to form an electrically lossy material and/or a magnetically lossy material.

Materials that conduct, but with some loss, over the frequency range of interest are referred to herein generally as “electrically lossy” materials. Electrically lossy materials can be formed from lossy dielectric and/or lossy conductive materials. The frequency range of interest depends on the operating parameters of the system in which such a connector is used, but will generally be between about 1 GHz and 30 GHz, though higher frequencies or lower frequencies may be of interest in some applications. In embodiments in which the insert is configured for insertion into a high-speed memory socket, the frequency range of interest may encompass frequencies of at least 30 GHz such that a memory bus is enabled to operate at data transfer rates in excess of 26 GB/s or 30 GB/s or 35 GB/s in some embodiments, even with an unpopulated connector attached to the bus. Data transfer rates of 38.4 GB/s, 43.2 GB/s, or 51.2 GB/s, for example, may be enabled.

Electrically lossy material can be formed from material traditionally regarded as dielectric materials, such as those that have an electric loss tangent greater than approximately 0.01 in the frequency range of interest. The “electric loss tangent” is the ratio of the imaginary part to the real part of the complex electrical permittivity of the material. Examples of materials that may be used are those that have an electric loss tangent greater than approximately 0.003 in the frequency range of interest.

Electrically lossy materials can also be formed from materials that are generally thought of as conductors, but are either relatively poor conductors over the frequency range of interest, contain particles or regions that are sufficiently dispersed that they do not provide high conductivity or otherwise are prepared with properties that lead to a relatively weak bulk conductivity over the frequency range of interest.

Electrically lossy materials may be partially conductive materials, such as those that have a surface resistivity between 1Ω/square and 10⁶Ω/square. In some embodiments, the electrically lossy material has a surface resistivity between 1Ω/square and 10³Ω/square. In some embodiments, the electrically lossy material has a surface resistivity between 10Ω/square and 100Ω/square. As a specific example, the material may have a surface resistivity of between about 20Ω/square and 40Ω/square.

Electrically lossy materials may have a conductivity of about 1 siemens/meter to about 1×10⁵ siemens/meter, such as between about 1 siemens/meter to about 30,000 siemens/meter. In some embodiments material with a bulk conductivity of between about 25 siemens/meter and about 500 siemens/meter or 50 to 200 siemens/meter may be used. As a specific example, material with a conductivity of about 50 siemens/meter may be used.

In some embodiments, the bulk resistivity is of an electrically lossy material is selected to provide some conduction, but with some loss. Bulk resistivity of an electrically lossy structure used herein may be between about 0.01 Ω-cm and 1 Ω-cm. In some embodiments, the bulk resistivity is between about 0.05 Ω-cm and 0.5 Ω-cm. In some embodiments, the bulk resistivity is between about 0.1 Ω-cm and 0.2 Ω-cm.

In some embodiments, electrically lossy material is formed by adding a filler that contains conductive particles to a binder. Examples of conductive particles that may be used as a filler to form an electrically lossy materials include carbon or graphite formed as fibers, flakes or other particles. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake. In some embodiments, the conductive particles disposed in a filler element may be disposed generally evenly throughout, rendering a conductivity of filler element that is generally constant. In other embodiments, a first region of filler element may be more conductive than a second region of the filler element so that the conductivity, and therefore amount of loss within filler element may spatially vary.

In some embodiments, a lossy material may alternatively or additionally comprise a magnetically lossy material. A magnetically lossy material may be formed of a binder or matrix material filled with particles that provide that layer with magnetically lossy characteristics. The magnetically lossy particles may be in any convenient form, such as flakes or fibers. Ferrites may be used as magnetically lossy materials. Materials such as magnesium ferrite, nickel ferrite, lithium ferrite, yttrium garnet or aluminum garnet may be used, for example.

The “magnetic loss tangent” is the ratio of the imaginary part to the real part of the complex magnetic permeability of the material. Materials with higher loss tangents may be used as a magnetically lossy material. Ferrites will generally have a loss tangent above 0.1 at the frequency range of interest. Ferrite materials may have a loss tangent between approximately 0.1 and 1.0 over the frequency range of 1 GHz to 3 GHz and more preferably a magnetic loss tangent above 0.5 in this frequency range.

It is possible that a material may simultaneously be a lossy dielectric or a lossy conductor and a magnetically lossy material. Such materials can be formed, for example, by using magnetically lossy fillers that are partially conductive or by using a combination of magnetically lossy and electrically lossy fillers.

The binder or matrix may be any material that will set, cure or can otherwise be used to position the filler material. In some embodiments, the binder may be a thermoplastic material such as is traditionally used in the manufacture of electrical connectors to facilitate the molding of the electrically lossy material into the desired shapes and locations as part of the manufacture of the electrical connector. Examples of such materials include LCP and nylon. However, other binder materials may be used. Curable materials, such as epoxies, can serve as a binder. Alternatively, materials such as thermosetting resins or adhesives may be used. Also, while the above-described binder materials may be used to create a lossy material by forming a binder around particle fillers, other techniques may be used. For example, particles may be impregnated into a formed matrix material or may be coated onto a formed matrix material, such as by applying a conductive coating to a plastic housing. As used herein, the term “binder” encompasses a material that encapsulates the filler, is impregnated with the filler or otherwise serves as a substrate to hold the filler.

Preferably, the fillers will be present in a sufficient volume percentage to allow conducting paths to be created from particle to particle. For example, when metal fiber is used, the fiber may be present in about 3% to 40% by volume. The amount of filler may impact the conducting properties of the material.

Filled materials may be purchased commercially, such as materials sold under the trade name Celestran® by Ticona. A lossy material, such as lossy conductive carbon filled adhesive preform, such as those sold by Techfilm of Billerica, Massachusetts, US may also be used. This preform can include an epoxy binder filled with carbon particles. The binder surrounds carbon particles, which acts as a reinforcement for the preform. Such a preform may be inserted in a wafer to form all or part of the housing. In some embodiments, the preform may adhere through the adhesive in the preform, which may be cured in a heat treating process. Various forms of reinforcing fiber, in woven or non-woven form, coated or non-coated may be used. Non-woven carbon fiber is one suitable material. Other suitable materials, such as custom blends as sold by RTP Company, can be employed, as the present invention is not limited in this respect.

An absorptive material may provide “bridging” between conductive elements. The bridging provides a lossy path between conducting elements over the frequency range of interest. The bridging may be provided by a physical connection to the conducting elements that are bridged. In addition, over the frequency range of interest, signals may couple between structures capacitively or otherwise without direct physical contact between the structures. For example, a conductive structure may be separated from a lossy structure by a sufficiently small distance that the capacitance between the structures is on the order of 0.01 μF or 0.1 μF measured at a frequency of 15 GHZ. Accordingly, “bridging” may not require direct physical contact between structures.

Regardless of how bridging is achieved, with bridging in place, each of the conductive elements is less likely to generate stub resonance. Because there is less resonance, substantially less EMI emissions and signal reflections at the unterminated stub may be generated. Alternatively or additionally, the energy of any stub resonance created is dissipated with a reduction in EMI and/or other undesired electrical characteristics.

In some embodiments, blade 920 may comprise a lossy material that provides a lossy path between a conductive element 400 serving as a signal conductor and ground.

The insert may be shaped to provide bridging between select conductive elements within a card edge connector without electrically impacting other conductive elements. FIG. 4A is a top plan view of card edge connector 100 with insert 900, with the connector 100 and insert partially cut-away along the line 4-4 shown in FIG. 2. FIG. 4A shows the top of the connector housing and a cross-section of the blade portion of the insert 900 in the Y-Z plane.

As shown, blade portion 1920 has regions 9201, 9203, 9205 that may have different shapes and/or compositions depending on the configuration of conductive element nearest to the different regions. A blade portion may be formed in this configuration, for example, by molding lossy material formed from a filled binder. As a specific example, injection molding may be used if the binder is nylon or other thermosetting plastic. In the example shown, conductive elements 4113 are power conductors, conductive elements 4111 are ground conductor, and the remaining conductive elements, such as conductive element 4115, are signal conductors. In this example, all of the visible signal conductors 4115 are high speed signal conductors and are bridged to the ground conductors.

Region 9201 may comprise lossy material in direct physical contact with ground conductor 4111, while region 9205 may be contacted by signal conductor 4115. As shown, a lossy path is formed between ground conductor 4111 and signal conductor 4115 via lossy material within the blade portion 920, such that stub resonance may be dampened or eliminated.

In the example of FIG. 4A, lossy paths between signal conductive elements and ground are formed via direct physical contact between the lossy material and the ground conductive elements. In embodiments where the lossy material is directly connected to ground conductive elements, it may be preferred that a power conductor is electrically isolated from the lossy material to reduce a risk of electrical short between a power conductor on a bus in the motherboard with ground. Isolation may be provided by, for example, an air gap or other dielectric materials separating the power conductor from the lossy material such that no DC connection is formed. In the example of FIG. 4A, region 9203 has a cut out to avoid direct physical contact of electrically lossy material with power conductor 4113. The cut out may also be shaped such that there is both sufficient DC isolation between the power conductor 4113 and the lossy material. The isolation may provide, for example, in excess of 1 MΩ. Alternatively or additionally, the separation between the power conductor 4113 and the lossy material may provide negligible amounts of capacitive coupling, such as less than 1 femtoFarad. However, in some systems, capacitive coupling may have no impact or may be desirable, and larger amounts of capacitive coupling may be provided.

FIG. 4B illustrates an alternative configuration for blade portion 1920, labeled blade portion 1920B. In blade portion 1920B, isolation is provided for power conductors through the incorporation of material in insulative regions 9203B. Insulative regions 9203B, for example, may be formed of plastic, nylon or other material that may be used as an insulator in a connector housing. As a specific example, insulative regions 9203B may be formed of the same material as a binder used to form a lossy body 420B of blade portion 1920. Use of lossy material formed as a binder with fillers enables blade portion 1920 to be simply formed in a two-shot molding operation. Lossy body 420B, for example, may be molded with a channel in it. That channel may then be filled in a second molding operation with an insulative material.

In the embodiments illustrated in FIGS. 4A and 4B, the electrically lossy material is exposed at the surfaces of a lossy body, such as lossy body 420A and 420B. In this configuration, a lossy path between a signal conductive element and a ground conductive element is formed by direct physical contact and direct electrical coupling between the mating contact portions of the conductive elements and the lossy material.

In other embodiments, the electrically lossy material may be statically isolated from the conductive element, and the lossy path may comprise capacitive coupling between the mating contact portion of a conductive element and the lossy material. In such embodiments, an insulative gap provides capacitive bridging at a frequency range of interest, while being insulative at direct current (DC) conditions.

FIG. 4C illustrates an alternative configuration for blade portion 1920, labeled blade portion 1920C in which there is capacitive coupling. In blade portion 1920C, surfaces 9110C and 9120C each have an insulative layer 430C and 432C, respectively, on them.

For high signal frequencies, such as those in the range of 10GHz or higher, bridging may be provided by sufficient capacitive coupling. In some embodiments, capacitive coupling may result from approximately between 0.01 picoFarad to 1.00 picoFarad of capacitance as measured at a frequency of 1 GHz between a lossy material and a conductive element 400. The conductive element, which may be a signal conductor, a ground conductor, or a power conductor, and may act, alone or together with other conductive elements, as a resonant electrical stub conductor. With sufficient capacitive coupling between the resonant conductor(s) and the lossy material, the quality factor of the resonant stub(s) may be reduced, and the negative effect of resonant stubs on electrical performance including crosstalk, transmission, radiated emissions, etc. may be mitigated.

A gap separating a conductive element and a lossy material may be an air gap. In the example of FIG. 3, an air gap may be provided using a region on blade 920 opposing a mating contact portion 4110 that has a recess or otherwise smaller thickness than the width T of the slot 330, such that mating contact portion 4110 is not in direct physical contact with the first surface 9110 in such a region.

In the embodiment of FIG. 4C, insulative layers 430C and 432C create a dielectric gap adjacent signal conductive elements and ground conductive elements, resulting in capacitive bridging between those conductive elements and lossy body 420C. In such embodiments, as the gap distance is essentially the thickness of the insulative layers, there may be more precise control of the capacitive coupling than when an air gap is used.

Having an insulative coating layer over a surface of lossy material on the blade 1920C may provide additional advantages. For example, an insulative coating may serve as physical protection to the lossy material by resisting abrasion. Such protection may result when the coating is harder than the binder material used to form blade 1920C. Alternatively or additionally, an insulative coating may serve as physical protection to the metal mating contact surface of a conductive element that would otherwise contact a blade portion 1920C. For example, gold plating on the mating contact portion 4110 may be susceptible to flaking/removal upon sliding across a surface of a lossy material formed by particulates in a binder. The composite material may provide an abrasive surface. Insulative layers 430C and 432C may provide smoother surfaces that are less abrasive, lowering the risk of damaging the gold plating.

An insulative coating over the lossy material may be formed, for example, with a commercially available material for use as conformal coatings to insulate and protect electronic circuit board assemblies, and the components and interconnections on these assemblies, from environmental exposure and deterioration. These coatings include such materials as the various formulations of parylene coatings, acrylic polymer conformal coatings, urethane polymer conformal coatings, one-part and two-part epoxy polymer coatings, silicone coatings, styrene coatings, and others. Any suitable manufacturing methods for applying and curing such coatings at a controlled thickness may be used. As a non-limiting example, a parylene coating may be applied in thicknesses ranging from 0.1 micron to more than 50 microns. The thicknesses of an insulative coating may be between 0.1 micron to 500 micron, between 1 and 500 micron, between 25 and 200 micron, between 50 and 200 micron, between 75 and 200 microns, or other values. Alternatively or additionally, an insulative layer may be applied as a film, such as a polyimide film. Such a film may be applied with adhesive and may be applied as a tape, for example, including an adhesive layer.

FIG. 4D illustrates an alternative configuration for blade portion 1920, labeled blade portion 1920D, in which there is a direct connection between ground conductive elements and a lossy body 420D and capacitive coupling between signal conductive elements and a lossy body 420D. In the example of FIG. 4D, insulative layers 430D and 432C are formed on surfaces of lossy body 420D where signal conductive elements contact the blade portion 1920D. Accordingly, capacitive coupling may be provided as described above in connection with FIG. 4C.

In the example of FIG. 4D, in contrast to the layers in FIG. 4C, the insulative layers 430D and 432D are interrupted where ground conductive elements contact blade portion 1920D. That interruption may be provided by a gap in the insulative layer. Alternatively, as illustrated in the example of FIG. 4D, the interruption may be provided by a structure extending at least partially through the insulative layer. That extending structure may be a projection of the lossy body 420D or may be an added structure, such as a metal pad, such as pad 440D. Metal pads may be incorporated into blade portion 1920D by insert molding, for example, or may be attached to the surface of insulative body before layers 430D and 432D are applied.

In the example of FIG. 4D, regions 9203D adjacent the power conductive elements are formed from cutout regions filled with insulative material, as described above in connection with FIG. 4B. However, the insulative material within regions 9203D may be formed with the same material as layers 430D and 432D. Regions 9203D may be fully or partially filled at the same times as layers 430D and 432D are formed. In some embodiments, regions 9203D may be partially filled with insulative material, to a depth approximating the thickness of layers 430D and 432D. The remainder of regions 9203D may be filled with other insulative material, such as air

FIG. 4D illustrates an embodiment in which different types of conductive elements (power, signal and ground) are coupled differently to a lossy body. The ground conductive elements are most tightly coupled. Conversely, the power conductive elements are most heavily insulated from the lossy body. The signal conductive elements are coupled to the lossy body, but with less coupling than the ground conductive elements. For high speed memory systems, that pattern of relative coupling based on type is theorized to provide a strong reduction in the problems associated with an unterminated stub in the connector, in combination with a low risk of interference with the system performance associated with inserting a lossy component into a connector attached to a motherboard in the system.

FIG. 4E illustrates an alternative configuration for blade portion 1920, labeled blade portion 1920E. In this example, blade portion 1920E has multiple portions, here shown as two portions 420D1 and 420D2, separated by a spine 450E. Each of the portions 420D1 and 420D2 may function as one side of blade portion 1920 described in connection with FIG. 4A, with surfaces for signal and ground conductive elements to directly contact the lossy material and recesses to prevent contact by power conductive elements.

Spine 450E, for example, may be a metal sheet and lossy material may be molded over the sheet to form portions 420D1 and 420D2. Such a configuration may reinforce blade portion 1920E and/or may increase the coupling between signal conductive element and ground conductive elements. Alternatively, spine 450E may be formed of an insulative material. An insulative spine, for example, may provide isolation between conductive elements contacting one of portions 420D1 or 420D2 and those contacting the other of the portions 420D1 or 420D2. In embodiments in which spine 450E is insulative, spine 450E may be formed in a molding operation during which regions 9203E may also be filled with insulative material.

It should be appreciated that FIGS. 4A . . . 4C illustrate combinations of techniques for providing varying degrees of coupling between different types of conductive elements and lossy material while also providing isolation, at least at DC, between power conductive elements and the ground conductive elements. These techniques may be used in any suitable combination.

In some embodiments, a blade with a lossy portion may be integrated into another structure that may otherwise be used with a cared edge connector, such as a dust cap or a pick and place cover. FIG. 4A illustrates an example of how a dust cap may protect the conductive elements from environmental factors. FIG. 4A shows that, in addition to exposure through slot 330, conductive elements are exposed within openings 314 on a top surface 312 of the housing 300. The openings 314 are also visible in the cross-section view diagram in FIG. 3. Insert 900 may comprise additional features outside slot 330 that cover up openings 314 such that when exposure from both within slot 330 and openings 314 are sealed when insert 900 is fully inserted into slot 330.

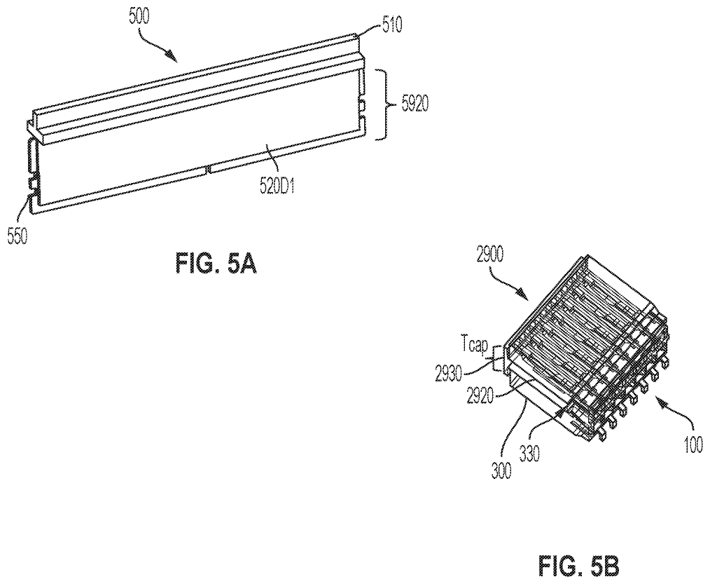

In some embodiments, a blade portion 5920 (FIG. 5A) may be formed as part of a dust cap 500. Blade portion 5920 may be configured as any of the blade portions described herein or in other suitable arrangement that provides lossy coupling between selected ones of the conductive elements in a connector as described herein. Dust cap 500 has a cap portion 510 that extends beyond a lateral extent of the slot 330 along the Z direction, such that the cap portion serves as a dust cap that covers at least a portion of the top surface of sidewalls 310, 320 outside the slot 330 FIG. 4A). Conductive elements within an unpopulated card edge connector may be exposed to dust, grime, moisture, or other environmental factors within a computer system. Surface contaminations on a contact surface of a conductive element may degrade the electrical contact resistance between the conductive element and a corresponding pad on a daughter card when the connector is later populated with a daughter card. Such risks may be reduced or eliminated by using a dust cap to limit or prevent environmental exposure of components in a connector.

Cap portion 510 may be molded of insulative material in a two-shot molding operation in which lossy material forms the second shot, as described above. When blade portion 5920 has a spine or other regions of insulative material, cap portion 510 may be molded in the same operation as those insulative regions. Alternatively, cap portion 510 may be formed of a sealing material, such as silicone rubber, that is molded onto or otherwise attached to blade portion 5920.

Cap portion 510 may be shaped and constructed as any dust cap for a card edge connector now known or hereafter developed, such that the same component may provide both dust protection as well as dampening of unterminated stub resonances in unpopulated connectors.

Alternatively or additionally, a blade portion of a lossy insert may be integrated with a cap with a flat surface that may be used as a pick and place cap. FIG. 5B is a partial perspective view of a card edge connector with the connector housing shown in phantom to reveal an insert with a cap portion and a blade portion, in accordance with some embodiments. In FIG. 5, blade portion 2920 of insert 2900 is fully inserted into slot 330 of card edge connector 100, such that absorptive material within blade portion 2920 may dampen stub resonance in conductive elements adjacent the absorptive material. In addition, insert 2900 also comprises cap portion 2930 disposed outside of slot 330 and extends laterally along the Z direction to protect top surfaces of insulative housing 300 from being exposed to the environment.

In some embodiments, a plurality of card edge connectors may be installed on a motherboard, and a maximum width T_{cap} for cap portion 2930 of insert 2900 along the Z direction may be limited to no larger than a center-to-center pitch of adjacent card edge connectors to avoid physically interfering with insertion and extraction of an insert or a daughtercard in an adjacent card edge connector.

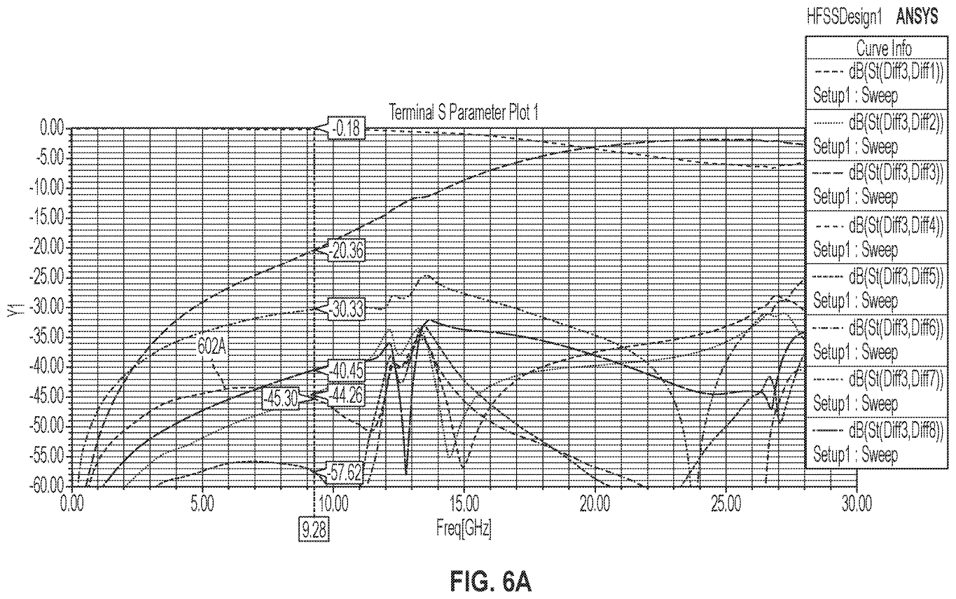

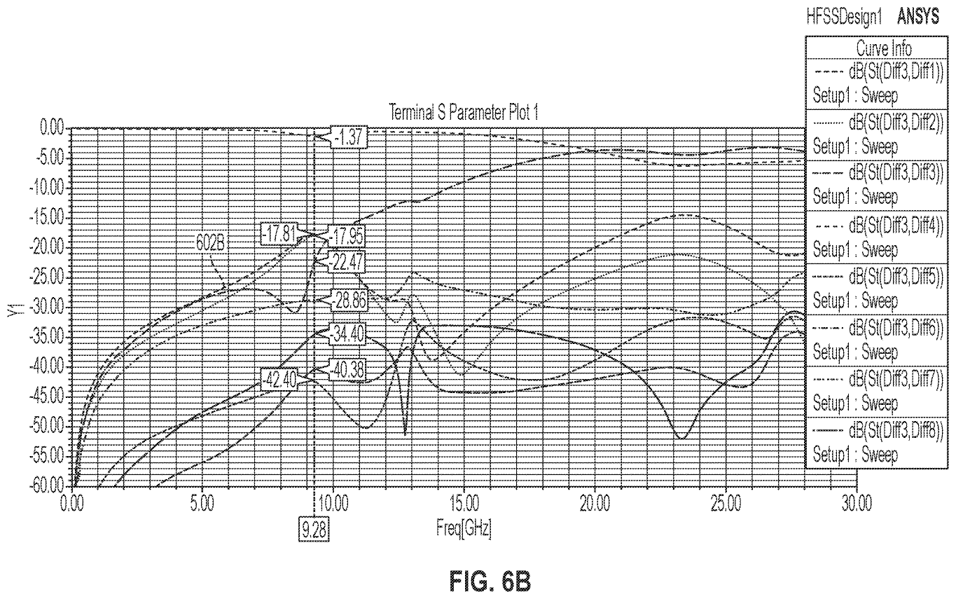

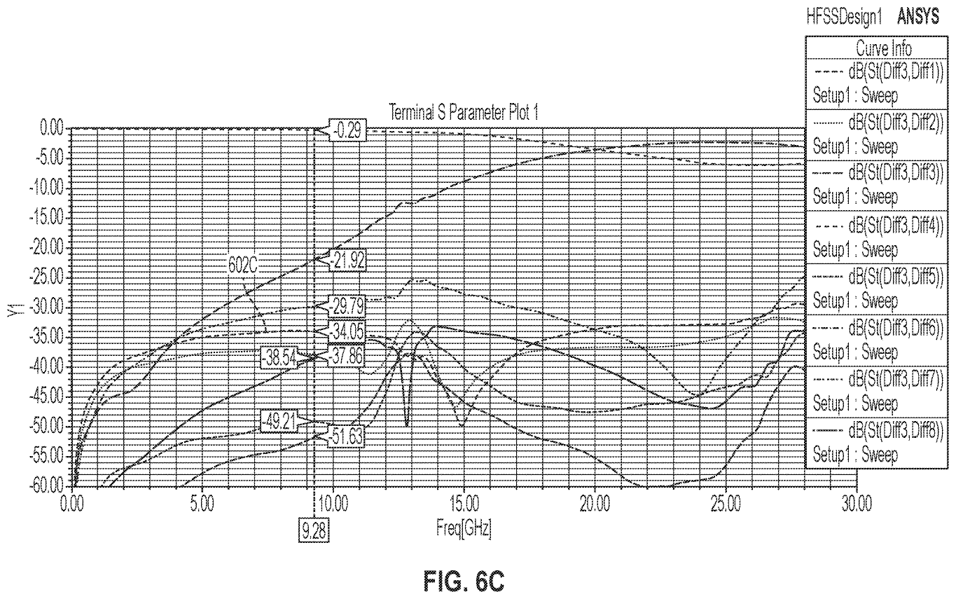

FIG. 6A is plot, derived through electromagnetic modeling, of S-parameters of a connector with a DDR memory card inserted. In FIG. 6A, curve 602A shows that at 9.28 GHZ, the terminal to terminal S-parameter between conductive elements Diff3 and Diff1 is −45.30 dB. FIG. 6B is a plot, derived through electromagnetic modeling, of S-parameters of the same connector used to generate the plot of FIG. 6A, but with the connector unpopulated. As shown by curve 602B in FIG. 6B, at 9.28 GHz, the terminal to terminal S-parameter between the same conductive elements Diff3 and Diff1 increased dramatically to −17.81 dB, suggesting a high frequency stub resonance as a result of the floating conductive elements. FIG. 6C is a plot, derived through electromagnetic modeling, of S-parameters of the same connector used to generate the plot of FIG. 6B with an insert having absorptive material to dampen stub resonance. In this example, a conductive plastic is used to short a ground conductive element and a signal conductive element within the connector while avoiding contact with any power conductive element, similar to the embodiment shown in FIG. 4. As shown by curve 602C in FIG. 6C, at 9.28 GHz, the stub resonance has been reduced to −34.05 dB, as a result of the resonance electromagnetic energy being dissipated within the conductive plastic.

Having thus described several aspects of at least one embodiment of this invention, it is to be appreciated that various alterations, modifications, and improvements will readily occur to those skilled in the art.

For example, a component with absorptive material was described for use in a card edge connector configured to receive a memory card. The techniques and components as described herein may be used in card edge connectors that receive other kinds of cards, such as processor cards, co-processor cards, graphics card, accelerator cards, etc. Moreover, a component with absorptive material may be inserted into connectors of other styles. For example, a component with absorptive material may be inserted into the mating interface of an internal I/O connector or other connector that may be installed in a computer or other electronic device and is initially unpopulated.

As described above, bridging may be provided by capacitively coupling an electrically lossy material between two conductors. Because no direct conducting path need be provided, it is also possible that the electrically lossy material may be discontinuous, with electrically insulating material between segments of electrically lossy material.

Some embodiments may use magnetically lossy material that are not electrically conductive as absorptive material. In such embodiments, magnetically lossy material may be in direct physical contact with some or all of the conductive elements, including power conductors, signal conductors and ground conductors, without risk of an electrical short between power and ground.

As another example, a card edge connector having conductive elements designated as power, ground and signal was described. It is not a requirement that a conductor have all or only these types of conductive elements. A connector, for example, may have only signal and ground conductors. Alternatively, a connector may have low speed signal conductors and high speed signal conductors. For such a connector, the absorptive material may be coupled to the high speed signal conductors and may optionally be coupled to low speed signal conductors.

As yet an example of another variation, absorptive material was described as formed by dispersing particulate into a binder. There is no requirement that the absorptive material has a uniform composition. Alternatively or additionally, absorptive material may comprise one or more discrete components, such as resistors interconnected by a conductive layer such as metal traces.

Further, any suitable thickness, spatial distribution and arrangement of an absorptive material within blade 920 may be used, as aspects of the present disclosure are not limited to a uniform or planar layer of absorptive material. For example, the absorptive material may be a lossy material that is provided on a surface of a non-lossy material core, and may be patterned only along regions close to conductive elements 400 when insert 900 is fully inserted into slot 330. Using a core may reduce the amount of lossy material need to form the blade 920, and provide cost savings. The core may be any suitable material. For example, the substrate core may be a PCB used in manufacturing of a daughtercard. In other examples, the substrate core may be a material used in a dust cap for a card edge connector, and lossy material may be applied to the dust cap such as by a molding or coating process.

In some embodiments, the lossy material may be applied only in the vicinity of mating contact portions of a conductive element that are to be coupled to ground through a lossy path. Though, lossy material may be applied to any combination of areas on the blade 920. In some embodiments, the thickness, placement and extent of the coating may be determined empirically to the extent the lossy material may be selected to reduce stub resonances to an acceptable level.

The lossy coating may be applied in any suitable way. For example, lossy filler may be incorporated into a paint, epoxy or other suitable binder and applied as a thin film over the surfaces of the blade portion 920 in regions where the lossy coating is desired. As another example, a lossy coating may be formed as a tape or film and then applied to the surfaces 9110, 9120 of the blade portion 920.

Some embodiments include a composite resistive structure that can serve as an absorptive material. The composite resistive structure may include a metal coating applied to select regions of the blade portion 920. A metal coating may comprise a thin layer of relatively low conductivity metal or metal alloys, such that the layer may be sufficiently resistive to dampen stub resonance when placed adjacent a conductive element. Alternatively or additionally, a conductive material may be applied in a sufficiently dilute layer that is sufficiently resistive to dampen stub resonance. In some embodiments, a metal coating may be applied to one or both side surfaces of the blade portion 920. As non-limiting examples, the metal coating may comprise stainless steel, Ti, Ni, Cr, NiCr alloy, or very thin layers of Cu. In some other examples, a composite resistive structure may include other suitable resistive material such as but not limited to a nickel-phosphorus coating.

As yet another variation, an insulative layer on a lossy body may be used to reduce abrasion of a mating contact portion of a conductive element coupled to the lossy body. Alternatively or additionally, a conductive lubricant may be applied to the surface of the lossy body and/or the lossy body may be filled with materials, such as graphite, that may yield a composite material with little abrasion.

Such alterations, modifications, and improvements are intended to be part of this disclosure and are intended to be within the scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A component for insertion into an unpopulated electrical connector comprising a mating interface, the component comprising:
a blade portion configured for insertion into the mating interface, the blade portion comprising a lossy body.

2. The component of claim 1, wherein the lossy body comprises a binder and ferrite fillers disposed within the binder.

3. The component of claim 1, wherein the lossy body comprises a binder and conductive fillers disposed within the binder.

4. The component of claim 3, wherein the lossy body has a bulk conductivity, measured at a frequency of 1 GHz of between 50 and 1,000 siemens/meter.

5.-6. (canceled)

7. The component of claim 1, wherein the component further comprises a cap mechanically coupled to the blade portion.

8.-9. (canceled)

10. The component of claim 1, wherein the blade portion comprises opposing edges and at least one notch in each of the edges configured to receive an engagement feature of the electrical connector.

11. The component of claim 1, wherein the blade portion has physical dimensions in accordance with a DDR5 specification.

12. The component of any of the preceding claims claim 1, wherein the lossy body comprises a plurality of insulative recesses configured to align with power conductive elements of the electrical connector.

13. An electrical connector comprising:
an insulative housing;
a plurality of conductive elements disposed in the insulative housing; and
a removable insert having at least a portion disposed adjacent at least one conductive element of the plurality of conductive elements, the portion comprising an absorptive material.

14. (canceled)

15. The electrical connector of claim 13, wherein:
the absorptive material comprises a lossy material.

16.-17. (canceled)

18. The electrical connector of claim 13, wherein:
the at least two conductive elements comprise a ground conductor and a signal conductor; and
the absorptive material is coupled to the ground conductor.

19.-22. (canceled)

23. The electrical connector of claim 18, wherein:
the portion of the insert comprises an insulative layer between the absorptive material and the signal conductor.

24. (canceled)

25. The electrical connector of claim 13, wherein:
the electrical connector is a card edge connector configured to mate with a daughtercard;
the insulative housing comprises a slot configured to receive the daughtercard;
the daughtercard is a memory card; and
the portion of the insert is disposed in the slot.

26. The electrical connector of claim 25, wherein:
the insert further comprises a cap covering at least a surface of the insulative housing outside the slot.

27.-38. (canceled)

39. A computer system comprising:
a memory bus;
a plurality of card edge connectors, each of the plurality of card edge connectors coupled to the memory bus and comprising a respective mating interface;
a memory card; and
an absorptive blade, wherein:
the plurality of card edge connectors comprises a first card edge connector and a second card edge connector;
the memory card is inserted in the mating interface of the first card edge connector; and
the absorptive blade is inserted in the mating interface of the second card edge connector.

40. The computer system of claim 39, wherein:
the memory bus comprises a plurality of signal conductors;
the computer system comprises at least one power conductor and at least one ground conductor; and
each of the plurality of card edge connectors comprises:
a plurality of signal conductive elements, each of the plurality of signal conductive elements soldered to a respective signal conductor of the plurality of signal conductors;
a plurality of power conductive elements, each of the plurality of power conductive elements soldered to a respective power conductor of the at least one power conductor;
a plurality of ground conductive elements, each of the plurality of ground conductive elements soldered to a respective ground conductor of the at least one ground conductor; and
the plurality of ground conductive elements of the second card edge connector are electrically coupled to the absorptive blade.

41. The computer system of claim 40, wherein:
the absorptive blade comprises a lossy body and the plurality of ground conductive elements of the second card edge connector are electrically coupled to the absorptive blade via an ohmic connection.

42. The computer system of claim 40, wherein:
the absorptive blade comprises a lossy body and the plurality of signal conductive elements of the second card edge connector are electrically coupled to the absorptive blade.

43. The computer system of claim 42, wherein:
the plurality of signal conductive elements of the second card edge connector are electrically coupled to the lossy body via a capacitive coupling with a capacitance of between 0.01 picoFarad to 1.00 picoFarad of capacitance as measured at a frequency of 1 GHz.

44. The computer system of claim 40, wherein:
the absorptive blade comprises a lossy body and the plurality of power conductive elements of the second card edge connector are electrically isolated from the lossy body by a DC resistance greater than 1 MOhm.
